(19) United States
(12) Patent Application Publication
(10) Pub. No.: US 2025/0173338 A1
(43) Pub. Date: May 29, 2025

(54) DYNAMICALLY SCALING A DISTRIBUTED DATABASE ACCORDING TO A CLUSTER-WIDE RESOURCE ALLOCATION

(71) Applicant: Amazon Technologies, Inc., Seattle, WA (US)

(72) Inventors: Sanjay Shanthakumar, Newark, CA (US); Praveen Kannan, Sunnyvale, CA (US); Aravind Kumar Kumar, Sammamish, WA (US); Raghavendran Gururajan, Redmond, WA (US); Suiyi Fu, Sunnyvale, CA (US); Sami I. Imseih, Niles, IL (US); Grant A. McAlister, Morro Bay, CA (US); Saleem Mohideen, Saratoga, CA (US); David Charles Wein, Shoreline, WA (US); Kaumudi Kaushik, Union City, CA (US); Kiran Pillarisetty, Hayward, CA (US); Amit Krishnan, Santa Clara, CA (US)

(73) Assignee: Amazon Technologies, Inc., Seattle, WA (US)

(21) Appl. No.: 18/518,916

(22) Filed: Nov. 24, 2023

(51) Int. Cl. G06F 16/2453; G06F 16/21; G06F 16/27

(52) U.S. Cl. CPC G06F 16/24545; G06F 16/217; G06F 16/27

(57) ABSTRACT

Dynamic scaling may be performed for a distributed database according to a cluster-wide resource allocation. Performance metrics for different query processing nodes of a distributed database system are obtained and evaluated to make scaling decisions for the database system. Scaling operations may include increasing or decreasing database capacity units allocated to a query processing node according to the cluster-wide allocation or adding a new query processing node to the cluster, the new node being allocated database capacity units from the cluster-wide allocation of database capacity units.

### BACKGROUND

Commoditization of computer hardware and software components has led to the rise of service providers that provide computational and storage capacity as a service. At least some of these services (e.g., database services) may be distributed in order to scale the processing capacity of the service and increase service availability. Moreover, the distribution of workload of services may result in uneven work performed across the service.

### BRIEF DESCRIPTION OF THE DRAWINGS

FIG. 1 is a logical block diagram illustrating dynamically scaling a distributed database according to a cluster-wide resource allocation, according to some embodiments.

FIG. 2 is a block diagram illustrating a provider network that may implement a database service that supports both a client-managed table and system-managed table in a common database for which dynamic scaling may be performed according to a cluster-wide resource allocation, according to some embodiments.

FIG. 3 is a block diagram illustrating various components of a database service and storage service that supports both a client-managed table and system-managed table in a common database, according to some embodiments.

FIG. 4 is a block diagram illustrating various interactions to handle database client requests, according to some embodiments.

FIG. 5 is a block diagram illustrating various interactions to handle database client requests, according to some embodiments.

FIG. 6 is a logical block diagram illustrating interactions for a database that includes both a client-managed table and a system-managed table, according to some embodiments.

FIG. 7 is a logical block diagram illustrating a router that performs intelligent query routing across client-managed and system-managed tables, according to some embodiments.

FIG. 8 is a logical block diagram illustrating local and cluster-wide heat management at a data access node, according to some embodiments.

FIG. 9 is a logical block diagram illustrating scaling DCUs at an individual data access node, according to some embodiments.

FIG. 10 is a logical block diagram illustrating splitting a shard at an individual data access node, according to some embodiments.

FIG. 11 is a high-level flowchart illustrating various methods and techniques to implement dynamically scaling a distributed database according to a cluster-wide resource allocation, according to some embodiments.

FIG. 12 is a high-level flowchart illustrating various methods and techniques to implement scaling database capacity units (DCUs) at a query processing node of a database system, according to some embodiments.

FIG. 13 is a high-level flowchart illustrating various methods and techniques to implement splitting a portion of a table to assign to a new query processing node, according to some embodiments.

FIG. 14 is a high-level flowchart illustrating various methods and techniques to implement adding a new distributed transaction node, according to some embodiments.

FIG. 15 is a block diagram illustrating an example computer system, according to various embodiments.

While embodiments are described herein by way of example for several embodiments and illustrative drawings, those skilled in the art will recognize that the embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). The words “include,” “including,” and “includes” indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION OF EMBODIMENTS

Techniques for dynamically scaling a distributed database according to a cluster-wide resource allocation are described herein. Workloads on a given component may sometimes be referred to as “heat.” Too much heat on any one component can slow down, disrupt, or even cause failures in distributed database systems. Thus “heat management techniques” remedy potential failures or other performance problems by shifting workloads or adding/reallocating resources to meet the workload.

In manually managed distributed database systems, system administrators may manually adjust various attributes of the distributed database system in order to account for heat. However, as the size of distributed database systems grows both in terms of data managed and complexity of components, manual heat management may often be performed too late to prevent performance problems. Moreover, because the interactions between components of distributed database systems have grown increasingly complex, the unintended effects of one action to alleviate heat at one component can introduce further heat problems by shifting the heat instead of dissipating the heat. In various embodiments, techniques for dynamically scaling a distributed database according to a cluster-wide resource allocation may quickly respond to heat on individual components, dissipating the heat without causing unintended consequences to other component without requiring administrator interventions. For many different systems, services, and applications that rely upon large-scale distributed database systems to support various operations, timely and effective heat management may prevent client outages or even more catastrophic failures. Thus, one of ordinary skill in the art may appreciate the various improvements to computer and database-related technologies that are achieved through the various embodiments described in detail below.

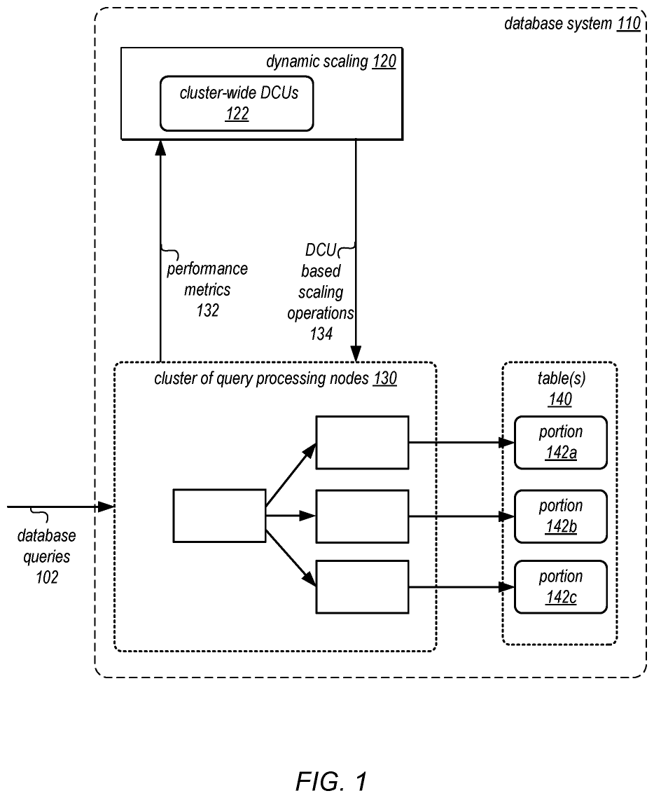

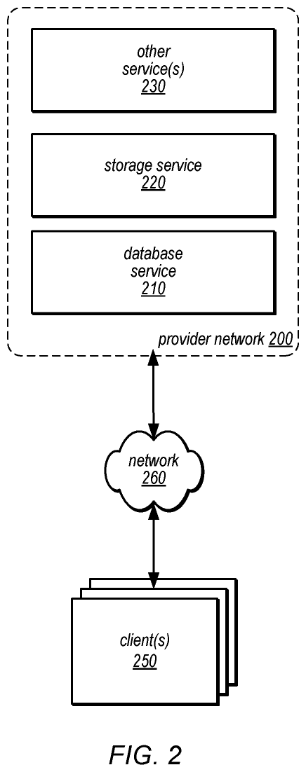

FIG. 1 is a logical block diagram illustrating dynamically scaling a distributed database according to a cluster-wide resource allocation, according to some embodiments. Database system 110 may be a distributed database system, similar to the database service discussed below with regard to FIGS. 2-10, or may be a standalone distributed database system (e.g., without distributed storage and/or separate storage). Database system 110 may host or manage access to database (e.g., with database data stored as one or more database tables 140). Database system 110 may implement a cluster of one or multiple query processing nodes 130, that may perform queries to the database. As depicted in FIG. 1, query processing nodes 130 may be assigned to different portions, 142a, 142b, and 142c, of a table 140 (also referred to as shards). As discussed in detail below with regard to FIGS. 2-10, in some embodiments, different query processing may perform different roles or actions, such as distributed transaction nodes and data access nodes, or may implement techniques such as leader and compute nodes or be implemented as a leaderless cluster.

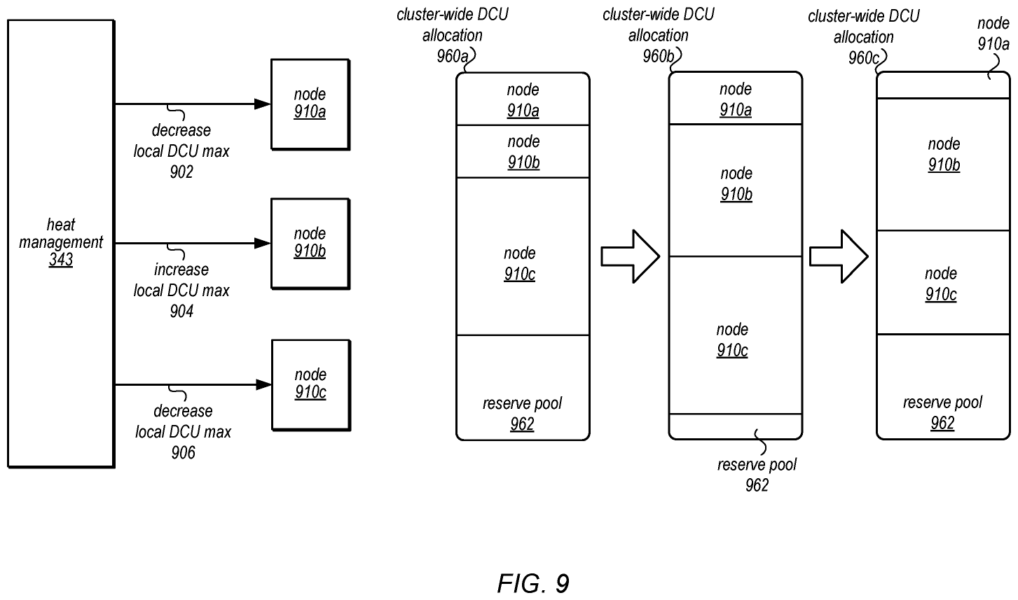

In order to ensure that the distribution of computing resources meets the workload of database queries 102, database system 110 may implement dynamic scaling 120 which may utilize a cluster-wide set of database capacity units (DCUs) 122 to make scaling decisions based on performance metrics 132, instructing them, as indicated at 134. Cluster-wide DCUs 122 may be a total number of DCUs that can be used across the cluster 130 (e.g., individual DCUs can be assigned differently to different nodes but the sum total of DCUs assigned across the nodes cannot exceed the cluster-wide DCUs). As discussed in detail below with regard to FIG. 9, in some embodiments a reserved pool of DCUs may be maintained. Performance metrics 132 may include various utilization of computing resources of query processing nodes (e.g., amount of processor, memory, network or other I/O bandwidth) and individual and/or aggregate query performance metrics (e.g., average latency, average wait time, etc.).

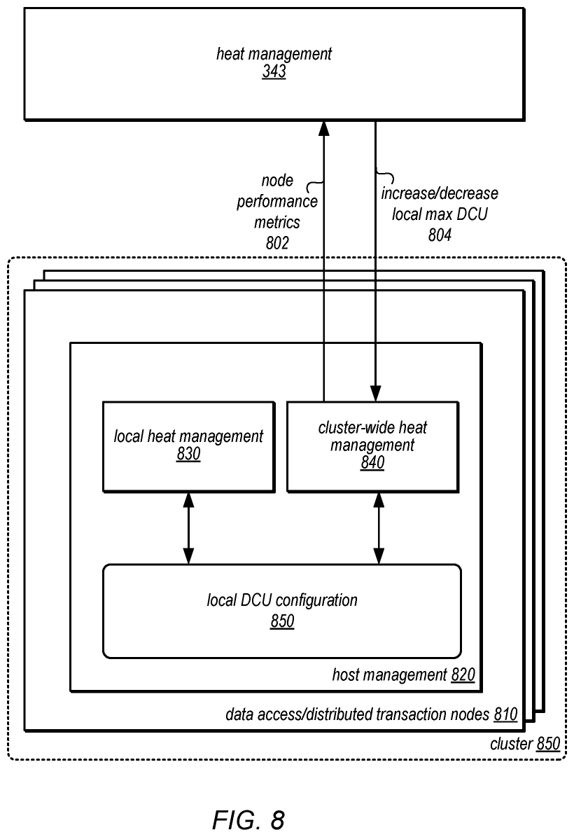

Various rules, criteria, and other considerations may be used by dynamic scaling 120, as discussed in detail below with regard to FIGS. 8-13. For example, the various performance metrics may be translated, represented, or evaluated with respect to DCUs. Thus if, for example, the actual performance of an individual node exceeds its DCU allocation, then that node may need to obtain more DCUs in order to continue handle the heat that is evidence by the actual performance. Different types of scaling decisions may be made, as discussed in detail below. For example, some scaling decisions may be made to change the DCU allocations at a query processing node, whereas other scaling decisions may include adding (or removing) nodes to cluster 130. By making scaling decisions with respect to a cluster-wide DCU allocation 122, dynamic scaling 120 can shift resource allocations to dissipate heat without exceeding resource utilization limits (e.g., which could otherwise cause performance degradation and unauthorized or excessive costs to operate the database system).

Please note, FIG. 1 is provided as a logical illustration of a database system, and is not intended to be limiting as to the physical arrangement, size, or number of components, modules, or devices to implement such features.

The specification continues with a description of an example network-based database service that implements dynamically scaling a distributed database according to a cluster-wide resource allocation may be implemented. Included in the description of the example network-based database service are various aspects of the example network-based database service, such as a data access node, distributed transaction node, control plane, and a storage service. The specification then describes flowcharts of various embodiments of methods for implementing dynamically scaling a distributed database according to a cluster-wide resource allocation. Next, the specification describes an example system that may implement the disclosed techniques. Various examples are provided throughout the specification.

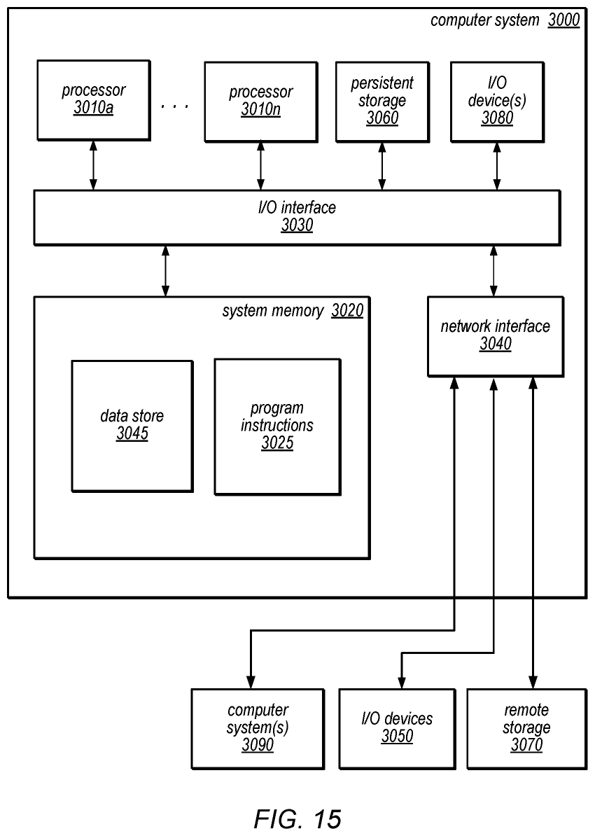

FIG. 2 is a block diagram illustrating a provider network that may implement a database service that implements dynamic scaling may be performed according to a cluster-wide resource allocation, according to some embodiments. A provider network, such as provider network 200, may be a private or closed system or may be set up by an entity such as a company or a public sector organization to provide one or more services (such as various types of cloud-based storage) accessible via the Internet and/or other networks to clients 250, in some embodiments. The provider network 200 may be implemented in a single location or may include numerous provider network regions that may include one or more data centers hosting various resource pools, such as collections of physical and/or virtualized computer servers, storage devices, networking equipment and the like (e.g., computing system 3000 described below with regard to FIG. 15), needed to implement and distribute the infrastructure and storage services offered by the provider network within the provider network regions.

For example, provider network can be formed as a number of regions, where a region is a separate geographical area in which the cloud provider clusters data centers. Each region can include two or more availability zones connected to one another via a private high speed network, for example a fiber communication connection. An availability zone (also known as an availability domain, or simply a “zone”) refers to an isolated failure domain including one or more data center facilities with separate power, separate networking, and separate cooling from those in another availability zone. A data center refers to a physical building or enclosure that houses and provides power and cooling to servers of the cloud provider network. Preferably, availability zones within a region are positioned far enough away from one other that the same natural disaster should not take more than one availability zone offline at the same time. Customers can connect to availability zones of the cloud provider network via a publicly accessible network (e.g., the Internet, a cellular communication network) by way of a transit center (TC). TCs can be considered as the primary backbone locations linking customers to the cloud provider network, and may be collocated at other network provider facilities (e.g., Internet service providers, telecommunications providers) and securely connected (e.g. via a VPN or direct connection) to the availability zones. Each region can operate two or more TCs for redundancy. Regions are connected to a global network connecting each region to at least one other region. The cloud provider network may deliver content from points of presence outside of, but networked with, these regions by way of edge locations and regional edge cache servers (points of presence, or PoPs). This compartmentalization and geographic distribution of computing hardware enables the cloud provider network to provide low-latency resource access to customers on a global scale with a high degree of fault tolerance and stability.

The provider network may implement various computing resources or services, which may include a virtual compute service, data processing service(s) (e.g., map reduce, data flow, and/or other large scale data processing techniques), data storage services (e.g., object storage services, block-based storage services, or data warehouse storage services) and/or any other type of network based services (which may include various other types of storage, processing, analysis, communication, event handling, visualization, and security services not illustrated). The resources required to support the operations of such services (e.g., compute and storage resources) may be provisioned in an account associated with the cloud provider, in contrast to resources requested by users of the cloud provider network, which may be provisioned in user accounts.

In the illustrated embodiment, a number of clients (shown as clients 250 may interact with a provider network 200 via a network 260. Provider network 200 may implement respective instantiations of the same (or different) services, a database services 210, proxy service 240, a storage service 220 and/or one or more other virtual computing service 230 across multiple provider network regions, in some embodiments. It is noted that where one or more instances of a given component may exist, reference to that component herein may be made in either the singular or the plural. However, usage of either form is not intended to preclude the other.

In various embodiments, the components illustrated in FIG. 2 may be implemented directly within computer hardware, as instructions directly or indirectly executable by computer hardware (e.g., a microprocessor or computer system), or using a combination of these techniques. For example, the components of FIG. 2 may be implemented by a system that includes a number of computing nodes (or simply, nodes), each of which may be similar to the computer system embodiment illustrated in FIG. 15 and described below. In various embodiments, the functionality of a given service system component (e.g., a component of the database service or a component of the storage service) may be implemented by a particular node or may be distributed across several nodes. In some embodiments, a given node may implement the functionality of more than one service system component (e.g., more than one database service system component).

Generally speaking, clients 250 may encompass any type of client configurable to submit network-based services requests to provider network region 200 via network 260, including requests for database services. For example, a given client 250 may include a suitable version of a web browser, or may include a plug-in module or other type of code module may execute as an extension to or within an execution environment provided by a web browser. Alternatively, a client 250 (e.g., a database service client) may encompass an application such as a database application (or user interface thereof), a media application, an office application or any other application that may make use of persistent storage resources to store and/or access one or more database tables. In some embodiments, such an application may include sufficient protocol support (e.g., for a suitable version of Hypertext Transfer Protocol (HTTP)) for generating and processing network-based services requests without necessarily implementing full browser support for all types of network-based data. That is, client 250 may be an application may interact directly with provider network 200. In some embodiments, client 250 may generate network-based services requests according to a Representational State Transfer (REST)-style web services architecture, a document- or message-based network-based services architecture, or another suitable network-based services architecture. Although not illustrated, some clients of provider network 200 services may be implemented within provider network 200 (e.g., a client application of database service 210 implemented on one of other virtual computing service(s) 230), in some embodiments. Therefore, various examples of the interactions discussed with regard to clients 250 may be implemented for internal clients as well, in some embodiments.

In some embodiments, a client 250 (e.g., a database service client) may be may provide access to network-based storage of database tables to other applications in a manner that is transparent to those applications. For example, client 250 may be may integrate with an operating system or file system to provide storage in accordance with a suitable variant of the storage models described herein. However, the operating system or file system may present a different storage interface to applications, such as a conventional file system hierarchy of files, directories and/or folders. In such an embodiment, applications may not need to be modified to make use of the storage system service model, as described above. Instead, the details of interfacing to provider network 200 may be coordinated by client 250 and the operating system or file system on behalf of applications executing within the operating system environment.

Clients 250 may convey network-based services requests to and receive responses from provider network 200 via network 260. In various embodiments, network 260 may encompass any suitable combination of networking hardware and protocols necessary to establish network-based communications between clients 250 and provider network 200. For example, network 260 may generally encompass the various telecommunications networks and service providers that collectively implement the Internet. Network 260 may also include private networks such as local area networks (LANs) or wide area networks (WANs) as well as public or private wireless networks. For example, both a given client 250 and provider network 200 may be respectively provisioned within enterprises having their own internal networks. In such an embodiment, network 260 may include the hardware (e.g., modems, routers, switches, load balancers, proxy servers, etc.) and software (e.g., protocol stacks, accounting software, firewall/security software, etc.) necessary to establish a networking link between given client 250 and the Internet as well as between the Internet and provider network 200. It is noted that in some embodiments, clients 250 may communicate with provider network 200 using a private network rather than the public Internet. For example, clients 250 may be provisioned within the same enterprise as a database service system (e.g., a system that implements database service 210 and/or storage service 220). In such a case, clients 250 may communicate with provider network 200 entirely through a private network 260 (e.g., a LAN or WAN that may use Internet-based communication protocols but which is not publicly accessible).

Generally speaking, provider network 200 may implement one or more service endpoints may receive and process network-based services requests, such as requests to access a database (e.g., queries, inserts, updates, etc.) and/or manage a database (e.g., create a database, configure a database, etc.). For example, provider network 200 may include hardware and/or software may implement a particular endpoint, such that an HTTP-based network-based services request directed to that endpoint is properly received and processed. In one embodiment, provider network 200 may be implemented as a server system may receive network-based services requests from clients 250 and to forward them to components of a system that implements database service 210, time synchronization service 240, storage service 220 and/or another service(s) 230 for processing. In other embodiments, provider network 200 may be configured as a number of distinct systems (e.g., in a cluster topology) implementing load balancing and other request management features may dynamically manage large-scale network-based services request processing loads. In various embodiments, provider network 200 may be may support REST-style or document-based (e.g., SOAP-based) types of network-based services requests.

In addition to functioning as an addressable endpoint for clients' network-based services requests, in some embodiments, provider network 200 may implement various client management features. For example, provider network 200 may coordinate the metering and accounting of client usage of network-based services, including storage resources, such as by tracking the identities of requesting clients 250, the number and/or frequency of client requests, the size of data tables (or records thereof) stored or retrieved on behalf of clients 250, overall storage bandwidth used by clients 250, class of storage requested by clients 250, or any other measurable client usage parameter. Provider network 200 may also implement financial accounting and billing systems, or may maintain a database of usage data that may be queried and processed by external systems for reporting and billing of client usage activity. In certain embodiments, provider network 200 may collect, monitor and/or aggregate a variety of storage service system operational metrics, such as metrics reflecting the rates and types of requests received from clients 250, bandwidth utilized by such requests, system processing latency for such requests, system component utilization, such as the target capacity determined for individual database engine head node instances, network bandwidth and/or storage utilization, rates and types of errors resulting from requests, characteristics of stored and databases (e.g., size, data type, etc.), or any other suitable metrics. In some embodiments such metrics may be used by system administrators to tune and maintain system components, while in other embodiments such metrics (or relevant portions of such metrics) may be exposed to clients 250 to enable such clients to monitor their usage of database service 210, storage service 220 and/or another service 230 (or the underlying systems that implement those services).

In some embodiments, provider network 200 may also implement user authentication and access control procedures. For example, for a given network-based services request to access a particular database table, provider network 200 ascertain whether the client 250 associated with the request is authorized to access the particular database table. Provider network 200 may determine such authorization by, for example, evaluating an identity, password or other credential against credentials associated with the particular database table, or evaluating the requested access to the particular database table against an access control list for the particular database table. For example, if a client 250 does not have sufficient credentials to access the particular database table, provider network 200 may reject the corresponding network-based services request, for example by returning a response to the requesting client 250 indicating an error condition. Various access control policies may be stored as records or lists of access control information by database service 210, storage service 220 and/or other virtual computing services 230.

Note that in many of the examples described herein, services, like database service 210 or storage service 220 may be internal to a computing system or an enterprise system that provides database services to clients 250, and may not be exposed to external clients (e.g., users or client applications). In such embodiments, the internal “client” (e.g., database service 210) may access storage service 220 over a local or private network (e.g., through an API directly between the systems that implement these services). In such embodiments, the use of storage service 220 in storing database tables on behalf of clients 250 may be transparent to those clients. In other embodiments, storage service 220 may be exposed to clients 250 through provider network region to provide storage of database tables or other information for applications other than those that rely on database service 210 for database management. In such embodiments, clients of the storage service 220 may access storage service 220 via network 260 (e.g., over the Internet). In some embodiments, a virtual computing service 230 may receive or use data from storage service 220 (e.g., through an API directly between the virtual computing service 230 and storage service 220) to store objects used in performing computing services 230 on behalf of a client 250. In some cases, the accounting and/or credentialing services of provider network region may be unnecessary for internal clients such as administrative clients or between service components within the same enterprise.

Note that in various embodiments, different storage policies may be implemented by database service 210 and/or storage service 220. Examples of such storage policies may include a durability policy (e.g., a policy indicating the number of instances of a database table (or data page thereof, such as a quorum-based policy) that will be stored and the number of different nodes on which they will be stored) and/or a load balancing policy (which may distribute database tables, or data pages thereof, across different nodes, volumes and/or disks in an attempt to equalize request traffic). In addition, different storage policies may be applied to different types of stored items by various one of the services. For example, in some embodiments, storage service 220 may implement a higher durability for redo log records than for data pages.

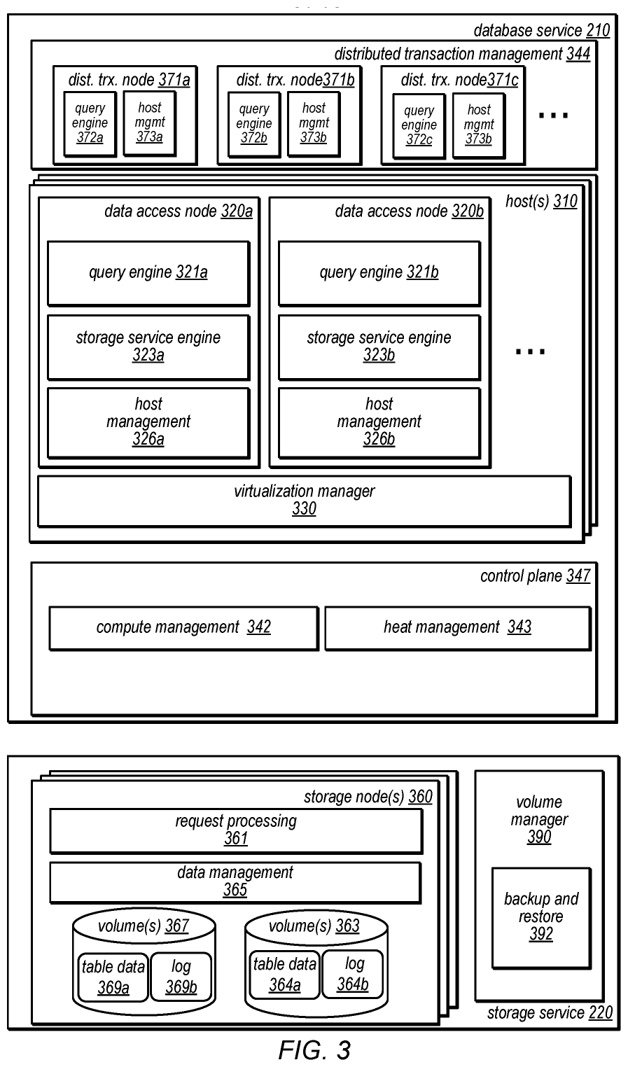

FIG. 3 is a block diagram illustrating various components of a database service and storage service that supports both a client-managed table and system-managed table in a common database, according to some embodiments. Database service 210 may implement control plane 347 which may manage the creation, provisioning, deletion, or other features of managing a database hosted in database service 210. For example, control plane 347 may monitor the performance of host(s) 310 (e.g., a computing system or device like computing system 3000 discussed below with regard to FIG. 15) via compute management 342 and shard management 346 (e.g., via heat management 341) for high workloads (e.g., heat) and move or shard assignments away from some hosts to avoid overburdening host(s) 310. Control plane 347 may handle various management requests, such as request to create databases, manage databases (e.g., by configuring or modifying performance, such as by enabling a “limitless table feature” or other automated management feature in response to a request which may cause in-place resource scaling to be enabled for that system-managed table. Control plane 347 may implement heat management 343, health monitoring and placement management, as well as overall compute management 342 (e.g., also for client-managed tables).

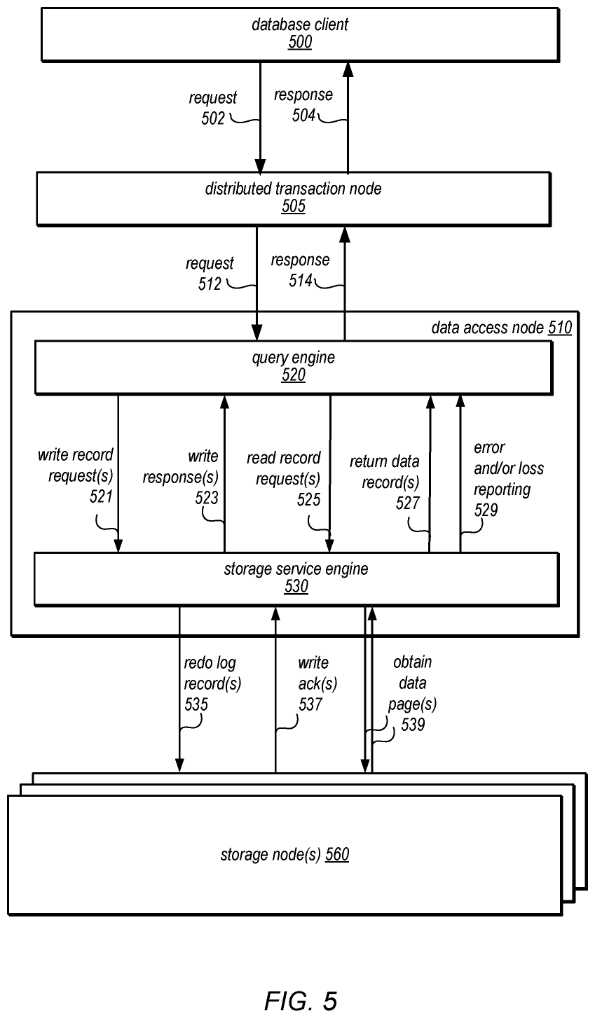

Database service 210 may implement one or more different types of database systems with respective types of query engines for accessing database data as part of the database. In at least some embodiments, database service 210 may be a relational database service that hosts relational databases on behalf of clients. For example, database service 210 may implement various types of connection-based (e.g., having established a network connection between a database client and a router for an endpoint of a database which may route requests to various data access nodes which may, for instance, facilitate the performance of various operations that continue over multiple communications between the database client and a connected pool of distributed transaction nodes 371a, 371b, 371c, and so on, of distributed transaction management layer 344 (or directly to a data access node in some scenarios as discussed below with regard to FIG. 5). In some embodiments distributed transaction nodes 371a, 371b, and 371c may implement respective query engines 372a, 372b, and 372c, which may perform some (or all) of query, transaction, or other access request handling, and respective host management 373a, 373b, and 373c.

In some embodiments, pool of distributed transaction nodes 371 may be assigned to a particular database, such that the combination of distributed transaction nodes 371 and data access nodes 320 may be considered a cluster. For example, when a client opens a client connection, the DNS (or NLB) will re-direct the physical socket connection to one of the distributed transaction nodes 371. Since the distributed transaction nodes 371 serve as the front end for all traffic, they may be implemented to be highly available. The distributed transaction nodes may be similar to (e.g., run same engine binaries) to data access nodes 310 and may, in some embodiments, host database tables (not illustrated). Each distributed transaction node 371 may be attached to one or more data stores to store metadata (and in some embodiments table data) and temporary tables or other temporary data that may need to be persisted locally. In some embodiments, a distributed transaction node 371 may be designated a distributed transaction node leader (e.g., one of a group of distributed transaction nodes). The distributed transaction node leader will be the primary owner of system-managed table metadata. The distributed transaction node leader may also serve as the coordinator when necessary for operations that might require serialization. In some embodiments, distributed transaction nodes 371 may be distributed across fault tolerance or other availability zones and may perform distributed transaction node failover (or distributed transaction node addition) in order to maintain high availability for a database to which the pool of distributed transaction nodes are assigned.

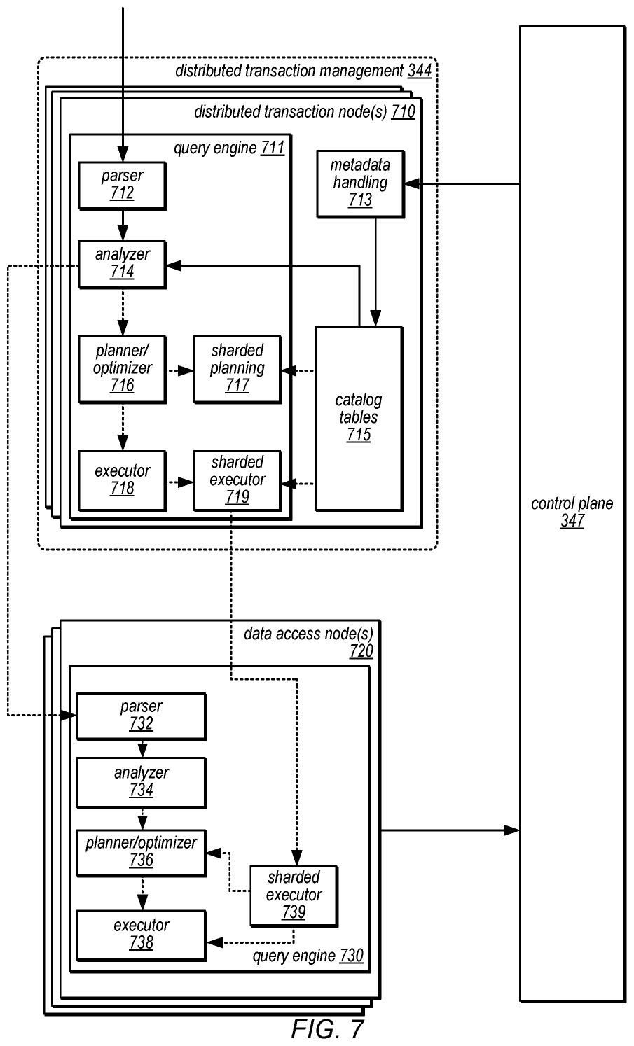

In some embodiments, distributed transaction nodes 371 may implement respective connection managers (not illustrated). As distributed transaction nodes may mostly pull the data from data access nodes for shards of a system-managed table (though not always as illustrated in some of the example distributed transaction techniques discussed below), in some embodiments, there may be a DB connection pool from every distributed transaction node 371 to every data access node (e.g., for a database). However, reusing connections from one query engine (at a distributed transaction node as depicted in FIG. 7) to another (e.g., to a query engine implemented on a data access node, also depicted in FIG. 7) cannot usually be done between users. In such scenarios, the connection manager may be responsible for cleaning up a database connection (with a client application as depicted in FIG. 5) after database session is closed (e.g., performing operations to clear data such as session configuration, user/role info, etc.) and starting processes, instances, or other components (e.g., pgBouncer instances for Postgres databases) for cases when new data access nodes 320 and distributed transaction nodes 371 nodes are added to a database with system-managed tables for a user as part of scale-out of data access nodes or distributed transaction nodes or recovery/replacement of existing data access nodes or distributed transaction nodes. When a new client application database connection to a distributed transaction node 371 needs to contact other nodes (e.g., distributed transaction node or a data access node) it does so through foreign data wrapper (FDW) managed foreign server, which may be modified to contact a local connection manager for getting an available database connection at which moment the session context may be set based on an original database connection to a distributed transaction node. This may include session configuration (e.g., selective) and user/role info. With that, request routing 344 may ensure that access to remote objects respects privileges and as data access nodes are computation nodes as well configuration is set (as it may not be common for FDW established connections which set just a user based on user mapping configured for a foreign server).

Database service 210 may implement a fleet of host(s) 310 which may provide, in various embodiments, a multi-tenant configuration so that different data access nodes, such as data access node 320a and 320b, can be hosted on the same host 310, but provide access to different databases on behalf of different clients over different connections. While hosts(s) 310 may be multi-tenant, each data access node 320 may be provisioned on host(s) 310 in order to implement in-place scaling (e.g., by overprovisioning resources initially and then scaling-based on workload to right-size the capacity that it is recorded as utilized for an account that owns or is associated with the database that is accessed by the data access node 320).

In various embodiments, host(s) 310 may implement a virtualization technology, such as virtual machine based virtualization, wherein database engine head node instances 320 may be different respective virtual machines, micro virtual machines (microVMs) which may offer a reduced or light-weight virtual machine implementation that retains use of individual kernels within a microVM, or containers which offer virtualization of an operating system using a shared kernel. Host(s) 310 may implement virtualization manager 330, which may support hosting one or multiple separate database engine head node instances 320 as different respective VMs, microVMs, or containers. Virtualization manager 330 may support increasing or decreasing resources made available to host(s) 310 to use for other tasks (including other database engine head node(s) 320) that were allocated to a data access node 320 upon creation at host(s) 310.

Data access node(s) 320 may support various features for accessing a database, such as query engine(s) 321a and 321b, and storage service engine(s) 323a and 323b discussed in detail below with regard to FIGS. 5-7. Data access nodes 320 may implement agents, interfaces, or other controls according to the respective type of virtualization used to collect and facilitate communication of utilization metrics for in-place scaling, among other supported aspects of virtualization, such as host management 326a and 326b. For example, host management 326 may implement resource utilization measurement, which may capture and/or access utilization information for host(s) 310 to determine which portion of utilization can be attributed to a specific database engine head node 320.

In some embodiments, database data for a database of database service 210 may be stored in a separate storage service 220. In some embodiments, storage service 220 may be implemented as to store database data as virtual disk or other persistent storage drives. In other embodiments, embodiments, storage service 220 may store data for databases using log-structured storage. Storage service 220 may implement volume manager 390, which may implement various features including backup and restore 392.

For example, in some embodiments, data may be organized in various logical volumes, segments, and pages for storage on one or more storage nodes 360 of storage service 220. For example, in some embodiments, each database may be represented by a logical volume, such as logical volumes 367 and 363 (which may include both table data 369a and corresponding log(s) 369(b) (e.g., redo logs). Table data 369a may be an entire table for a client-managed table or a shard of a system-managed table, as discussed in detail below. In some embodiments, volume(s) 363 may store metadata 364a for a database and a respective change log 364b. Each logical volume may be segmented over a collection of storage nodes 360. Each segment of a logical volume, which may live on a particular one of the storage nodes, may contain a set of contiguous block addresses, in some embodiments. In some embodiments, each segment may store a collection of one or more data pages and a change log (also referred to as a redo log) (e.g., a log of redo log records) for each data page that it stores. Storage nodes 360 may receive redo log records and to coalesce them to create new versions of the corresponding data pages and/or additional or replacement log records (e.g., lazily and/or in response to a request for a data page or a database crash). In some embodiments, data pages and/or change logs may be mirrored across multiple storage nodes, according to a variable configuration (which may be specified by the client on whose behalf the databases is being maintained in the database system). For example, in different embodiments, one, two, or three copies of the data or change logs may be stored in each of one, two, or three different availability zones or regions, according to a default configuration, an application-specific durability preference, or a client-specified durability preference.

In some embodiments, a volume may be a logical concept representing a highly durable unit of storage that a user/client/application of the storage system understands. A volume may be a distributed store that appears to the user/client/application as a single consistent ordered log of write operations to various user pages of a database, in some embodiments. Each write operation may be encoded in a log record (e.g., a redo log record), which may represent a logical, ordered mutation to the contents of a single user page within the volume, in some embodiments. Each log record may include a unique identifier (e.g., a Logical Sequence Number (LSN)), in some embodiments. Each log record may be persisted to one or more synchronous segments in the distributed store that form a Protection Group (PG), to provide high durability and availability for the log record, in some embodiments. A volume may provide an LSN-type read/write interface for a variable-size contiguous range of bytes, in some embodiments.

In some embodiments, a volume may consist of multiple extents, each made durable through a protection group. In such embodiments, a volume may represent a unit of storage composed of a mutable contiguous sequence of volume extents. Reads and writes that are directed to a volume may be mapped into corresponding reads and writes to the constituent volume extents. In some embodiments, the size of a volume may be changed by adding or removing volume extents from the end of the volume.

In some embodiments, a segment may be a limited-durability unit of storage assigned to a single storage node. A segment may provide a limited best-effort durability (e.g., a persistent, but non-redundant single point of failure that is a storage node) for a specific fixed-size byte range of data, in some embodiments. This data may in some cases be a mirror of user-addressable data, or it may be other data, such as volume metadata or erasure coded bits, in various embodiments. A given segment may live on exactly one storage node, in some embodiments. Within a storage node, multiple segments may live on each storage device (e.g., an SSD), and each segment may be restricted to one SSD (e.g., a segment may not span across multiple SSDs), in some embodiments. In some embodiments, a segment may not be required to occupy a contiguous region on an SSD; rather there may be an allocation map in each SSD describing the areas that are owned by each of the segments. As noted above, a protection group may consist of multiple segments spread across multiple storage nodes, in some embodiments. In some embodiments, a segment may provide an LSN-type read/write interface for a fixed-size contiguous range of bytes (where the size is defined at creation). In some embodiments, each segment may be identified by a segment UUID (e.g., a universally unique identifier of the segment).

In some embodiments, a page may be a block of storage, generally of fixed size. In some embodiments, each page may be a block of storage (e.g., of virtual memory, disk, or other physical memory) of a size defined by the operating system, and may also be referred to herein by the term “data block”. A page may be a set of contiguous sectors, in some embodiments. A page may serve as the unit of allocation in storage devices, as well as the unit in log pages for which there is a header and metadata, in some embodiments. In some embodiments, the term “page” or “storage page” may be a similar block of a size defined by the database configuration, which may typically a multiple of 2, such as 4096, 8192, 16384, or 32768 bytes.

In some embodiments, storage nodes 360 of storage service 220 may perform some database system responsibilities, such as the updating of data pages for a database, and in some instances perform some query processing on data. As illustrated in FIG. 3, storage node(s) 360 may implement data page request processing 361, and data management 365 to implement various ones of these features with regard to the data pages 367 and page log 369 of redo log records among other database data in a database volume stored in log-structured storage service. For example, data management 365 may perform at least a portion of any or all of the following operations: replication (locally, e.g., within the storage node), coalescing of redo logs to generate data pages, snapshots (e.g., creating, restoration, deletion, etc.), clone volume creation, log management (e.g., manipulating log records), crash recovery, and/or space management (e.g., for a segment). Each storage node may also have multiple attached storage devices (e.g., SSDs) on which data blocks may be stored on behalf of clients (e.g., users, client applications, and/or database service subscribers), in some embodiments. Data page request processing 361 may handle requests to return data pages of records from a database volume, and may perform operations to coalesce redo log records or otherwise generate a data pages to be returned responsive to a request. Although not illustrated, volumes 367 may store a commit log (as illustrated above with regard to FIG. 1) as part of table data 364a and 369a, log 369b and 364b, or as its own data structure within volumes 367 and 363.

In at least some embodiments, storage nodes 360 may provide multi-tenant storage so that data stored in part or all of one storage device may be stored for a different database, database user, account, or entity than data stored on the same storage device (or other storage devices) attached to the same storage node. Various access controls and security mechanisms may be implemented, in some embodiments, to ensure that data is not accessed at a storage node except for authorized requests (e.g., for users authorized to access the database, owners of the database, etc.).

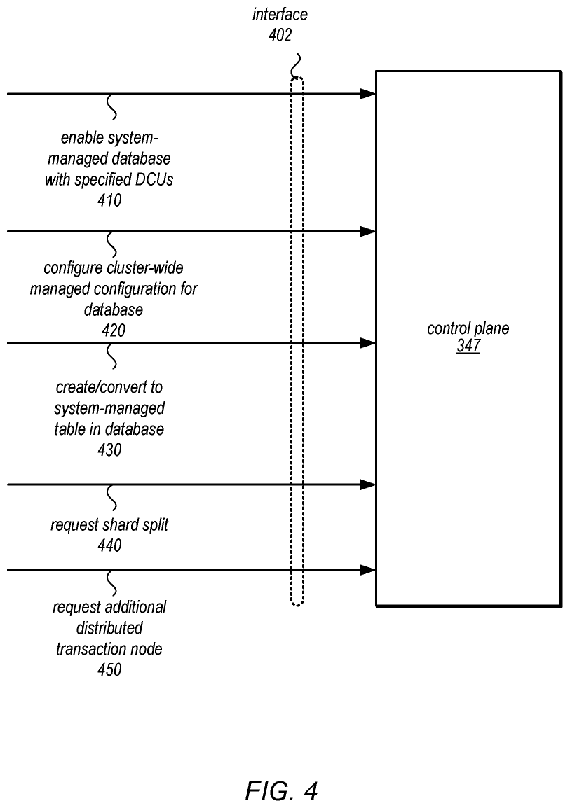

FIG. 4 illustrates interactions with a control plane of a database service for managing system-managed tables, according to some embodiments. Interface 402 may be a command line, programmatic (e.g., API), or graphical user interface for control plane 347. As indicated at 410, a request to enable (or disable) a system-managed database may be received with a specified number of DCUs (e.g., a maximum DCUs for the cluster providing access to a database of one or more tables, including either system-managed tables, client-managed tables, and/or both system-managed and client-managed tables), in some embodiments. For example, the database may be identified (e.g., by identifier such as a number or resource number) along with the parameter set to specify the number of DCUs. In some embodiments, various system-management parameters, such as a minimum number of DCUs or scaling configuration, such as how frequently to evaluate for scaling or perform scaling). When the system-managed database is created, the specified DCUs may be evenly distributed across the number of nodes in the cluster (e.g., such that the cumulative total of data access node DCU allocations and distributed transaction node DCU allocations does not exceed the specified number of DCUs).

As indicated at 420, these features parameters can be separately configured to add, remove, or change the parameters as request to configure cluster-wide managed configuration for the database. For example, the maximum DCUs for the cluster can be increased (or decreased) via request 420. In some embodiments, an increase or decrease may trigger an automatic adjustment to DCU allocations to individual nodes in a cluster (e.g., raising or lowering the local max DCUs). In some embodiments, the configuration may include parameters to configure the availability of the database (or one or more specific tables thereof) across one (or more) availability zones.

Enabling a system-managed database may cause the creation of (or transfer of) a network endpoint (e.g., a network address) that is specific to the database to route requests to distributed transaction layer 344 (which may assign or distribute the request to connect the database to different ones of distributed transaction nodes 371 according to a load balancing scheme). In this way, connection requests to access the database (e.g., whether for a system-managed table or client-managed table) may be routed through request distributed transaction node 344 (e.g., instead of being routed directly to an existing data access node already assigned to a current client-managed table of the database). These system-managed database parameters may be stored or updated in an administrative database and/or database metadata that is used to control database service 210 management of the database using various control plane features.

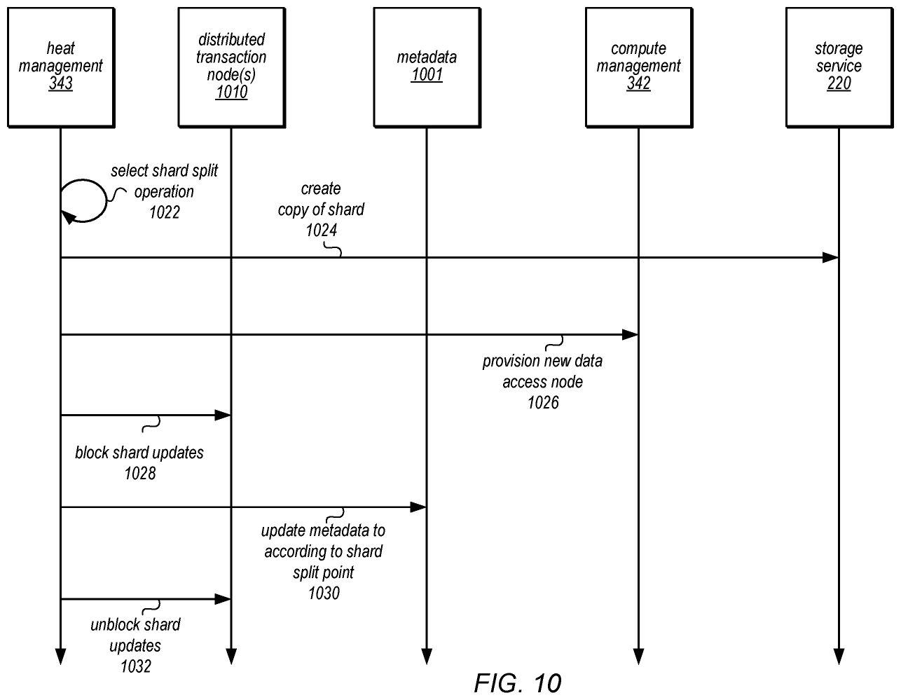

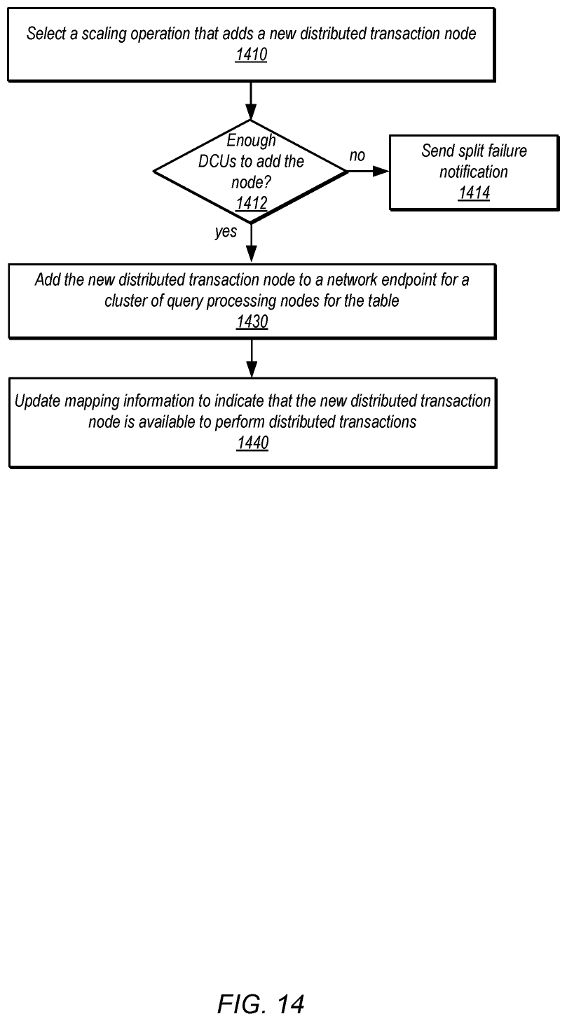

In some embodiments, control plane 347 may receive request to create or convert an existing client-managed table to a system-managed table in a database, as indicated at 430 or request a shard split, as indicated at 440 (as discussed in detail below with regard to FIGS. 10, 13, and 14). In some embodiments, a request to add a distributed transaction node (as discussed below with regard to FIG. 14) may be supported, as indicated at 450. In some embodiments, these requests may be received at the data access node for the database directly or at a distributed transaction node and thus may be received through the “data plane.” These requests, however may then be forwarded or dispatched to control plane 347 to direct the operations to complete the requests.

Control plane 347 may perform the various operations to create or alter tables to system-managed tables and/or to create or enable a system-managed database. For example, aligned tables may be identified and stored across different shards, according to an initial placement hierarchy that may be determined for the system-managed table(s) (e.g., a default or standard hierarchy may be initially used and then modified overtime according various heat or operations). Various migration techniques may be used to move the existing table data to the appropriate shard or store, when received, new data into a table (e.g., as part of insert requests or batch updates to add table data). Control plane 347 may initialize or update metadata to identify the new (or altered) system-managed table so that distributed transaction nodes may correctly identify and route requests to the appropriate data access nodes. Control plane 347 may also provision or assign data access nodes to shards of the system-managed table.

FIG. 5 is a block diagram illustrating various interactions to handle database client requests, according to some embodiments. In the example database system implemented as part of database service 210, a database engine head node 510 may be implemented for each database and storage nodes 560 (which may or may not be visible to the clients of the database system and may be similar to storage nodes 360 discussed above with regard to FIG. 3). Clients of a database may access a data access node 510 directly in some embodiments (as indicated at request 501 and response 503 instead of through distributed transaction node 510, such as requests that are directed to client-managed tables) via network utilizing various database access protocols (e.g., Java Database Connectivity (JDBC) or Open Database Connectivity (ODBC)). However, storage nodes 560, which may be employed by the database service 210 to store data pages of one or more databases (and redo log records and/or other metadata associated therewith) on behalf of clients, and to perform other functions of the database system as described herein, may or may not be network-addressable and accessible to database clients directly, in different embodiments. For example, in some embodiments, storage nodes 560 may perform various storage, access, change logging, recovery, log record manipulation, and/or space management operations in a manner that is invisible to clients of a data access node 510.

As previously noted, a data access node 510 may implement query engine 520 and storage service engine 530, in some embodiments. Query engine 520 may receive requests, like request 512, which may include queries or other requests such as updates, deletions, etc., from a distributed transaction node 505 connected to a database client 500 which first received the request 502 from the database client 500. Implementing a distributed transaction node 505 between database client 500 and data access node 510 may allow for database service 210 implement both client-managed tables and system-managed tables in the same database, as discussed in detail below. Query engine 520 then parses them, optimizes them, and develops a plan to carry out the associated database operation(s), as discussed in detail below with regard to FIG. 7.

Query engine 520 may return a response 514 to the request (e.g., results to a query) which distributed transaction node 505 may provide as response 504 to database client 500, which may include write acknowledgements, requested data (e.g., records or other results of a query), error messages, and or other responses, as appropriate. As illustrated in this example, data access node 510 may also include a storage service engine 530 (or client-side driver), which may route read requests and/or redo log records to various storage nodes 560 within storage service 220, receive write acknowledgements from storage nodes 560, receive requested data pages from storage nodes 560, and/or return data pages, error messages, or other responses to query engine 520 (which may, in turn, return them to a database client).

In this example, query engine 520 or another database system management component implemented at data access node 510 (not illustrated) may manage a data page cache, in which data pages that were recently accessed may be temporarily held. Query engine 520 may be responsible for providing transactionality and consistency in the database of which data access node 510 is a component. For example, this component may be responsible for ensuring the Atomicity, Consistency, and Isolation properties of the database and the transactions that are directed that the database, such as determining a MVCC snapshot time of the database applicable for a query, applying undo log records to generate prior versions of tuples of a database. Query engine 520 may manage an undo log to track the status of various transactions and roll back any locally cached results of transactions that do not commit.

For example, a request 512 that includes a request to write to a page may be parsed and optimized to generate one or more write record requests 521, which may be sent to storage service engine 530 for subsequent routing to storage service nodes 560. In this example, storage service engine 530 may generate one or more redo log records 535 corresponding to each write record request 521, and may send them to specific ones of the storage nodes 560 of storage service 220. Storage nodes 560 may return a corresponding write acknowledgement 537 for each redo log record 535 (or batch of redo log records) to data access node 510 (specifically to storage service engine 530). Storage service engine 530 may pass these write acknowledgements to query engine 520 (as write responses 523), which may then send corresponding responses (e.g., write acknowledgements) to one or more clients as a response 514.

In another example, a request that is a query may cause data pages to be read and returned to query engine 520 for evaluation. For example, a query could cause one or more read record requests 525, which may be sent to storage service engine 530 for subsequent routing to storage nodes 560. In this example, storage service engine 530 may send these requests to specific ones of the storage nodes 560, and storage nodes 560 may return the requested data pages 539 to data access node 510 (specifically to storage service engine 530). Storage service engine 530 may send the returned data pages to query engine 520 as return data records 527, and query engine 520 may then evaluate the content of the data pages in order to determine or generate a result of a query sent as a response 514.

In some embodiments, various error and/or data loss messages 541 may be sent from log-structured storage service 550 to data access node 510 (specifically to storage service engine 530). These messages may be passed from storage service engine 530 to query engine 520 as error and/or loss reporting messages 529, and then to one or more clients as a response 514.

In some embodiments, the APIs 535-539 to access storage nodes 560 and the APIs 521-529 of storage service engine 530 may expose the functionality of storage service 220 to data access node 510 as if data access node 510 were a client of storage service 220. For example, data access node 510 (through storage service engine 530) may write redo log records or request data pages through these APIs to perform (or facilitate the performance of) various operations of the database system implemented by the combination of data access node 510 and storage nodes 560 (e.g., storage, access, change logging, recovery, and/or space management operations).

Note that in various embodiments, the API calls and responses between data access node 510 and storage nodes 560 (e.g., APIs 521-529) and/or the API calls and responses between storage service engine 530 and query engine 520 (e.g., APIs 535-539) in FIG. 5 may be performed over a secure proxy connection (e.g., one managed by a gateway control plane), or may be performed over the public network or, alternatively, over a private channel such as a virtual private network (VPN) connection. These and other APIs to and/or between components of the database systems described herein may be implemented according to different technologies, including, but not limited to, Simple Object Access Protocol (SOAP) technology and Representational state transfer (REST) technology. For example, these APIs may be, but are not necessarily, implemented as SOAP APIs or RESTful APIs. SOAP is a protocol for exchanging information in the context of Web-based services. REST is an architectural style for distributed hypermedia systems. A RESTful API (which may also be referred to as a RESTful web service) is a web service API implemented using HTTP and REST technology. The APIs described herein may in some embodiments be wrapped with client libraries in various languages, including, but not limited to, C, C++, Java, C# and Perl to support integration with data access node 510 and/or storage nodes 560.

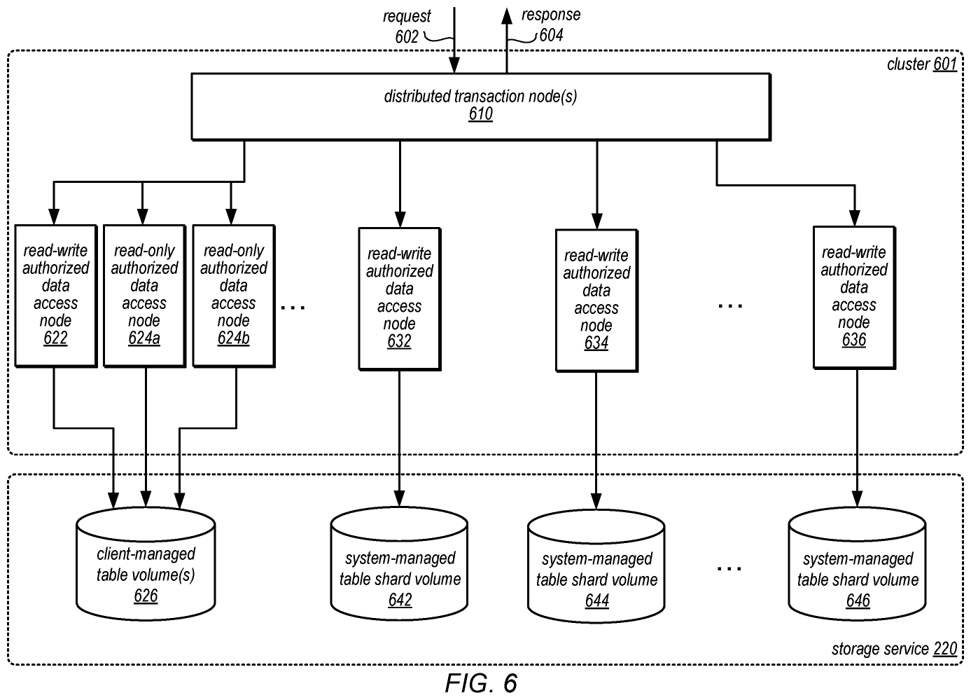

FIG. 6 is a logical block diagram illustrating interactions for a database that includes both a client-managed table and a system-managed table. Request 602 may be received at one of many distributed transaction nodes 610 that are implemented as part of cluster 601, as discussed above with regard to FIG. 3. A distributed transaction node 610 may accept the request and direct it to the appropriate data access nodes using both the query planning location selection techniques and, if a transaction, commit protocol techniques, discussed below with regard to FIG. 7. A client-managed table may be stored in a client-managed table volume 626 which may be connected to assigned data access nodes, such as read-write authorized data access node 622. In some embodiments, read-only nodes 624a and 624b, can also be assigned to increase read capacity. As discussed above with regard to FIG. 5, data access node 622 can request data pages, send redo log records, and otherwise interact with client-managed table volumes for portions of access requests targeted to client-managed tables.

For a system-managed table, multiple shards may be determined assigned to different read-write data access nodes 632, 634, and 636 respectively for shards stored in volumes 642, 644, and 646. Although not illustrated, read-only nodes may also be assigned to shards in order to satisfy the workload requirements on system-managed tables. The number of assigned data access nodes and shards for a system-managed table may change over time as additional compute or storage capacity is needed. These changes may be determined automatically by database service 210 (e.g., via heat management 343).

FIG. 7 is a logical block diagram illustrating a distributed transaction node that performs intelligent query routing across client-managed and system-managed tables, according to some embodiments. Distributed transaction nodes 710 may implement a query engine 711. When an access request is received, query engine 711 may parse the request at parser 712 and analyze the request at analyzer 714 to determine which shards or client-managed tables should be accessed to perform the access request according to catalog tables 715, which may be synchronized using control plane 347 to obtain up-to-date shard, data access node, and other assignments for tables in the database. Then, according to the analysis 714 different planning location(s) and execution paths (illustrated by the dotted line paths) may result. For example, network I/O minimization may be used to select between different distributed execution plans for access requests, in some embodiments.

For example, for distributed transaction node-selected planning, planner/optimizer 716 may generate a query plan and pass the plan off to sharded planning 717, which may add features to aggregate results from multiple data access nodes at shards (and also a client-managed table if included in a request with one or more shards). The sharded plan may then be passed to executor 718 which may provide instructions to sharded executor 719 to perform at data access node(s) 720. Data access nodes 720 may perform different requests according to different execution paths (e.g., receiving subsets of plans for further planning/optimization 736 and then execution through sharded executor 739, or straight to executor 738 via sharded executor 739). Alternatively, when a data access node is involved in performing a request (e.g., at only one data access node), then the request may be sent for parsing 732, analysis 734, planning/optimization 736, and optimization 738. Although not depicted results may be returned from the data access node(s) 720 to distributed transaction node 710 to return to a client (as depicted in FIG. 5).

Updates that are caused to metadata (e.g., changes to database schemas by Data Definition Language (DDL) requests or modifications to client-managed tables that are replicated), may be reported through metadata service 348.

FIG. 8 is a logical block diagram illustrating local and cluster-wide heat management at a data access node, according to some embodiments. As discussed above with regard to FIG. 3, data access nodes and distributed transaction nodes may implement host management to perform various management operations on a data access node and distributed transaction node as part of database service 210. One management operation relates to heat management. For example, database/distributed transaction nodes 810 may implement host management 820, which implements both local heat management 830 and cluster-wide heat management 840. Local heat management 830 may implement various resource allocation and local scaling criteria to adjust the resources allocated to database/distributed transaction nodes 810 at a host (e.g., via virtualization manager 330 as depicted in FIG. 3) to increase or decrease memory, processor, or other computation resource allocations locally at the host for database/distributed transaction nodes 810. These decisions may be made in accordance with local DCU configuration 850, which may include specified minimum and maximum DCU values that are local to data access/distributed transaction nodes 810. Note that various other threshold values may be used in addition to minimum and maximum threshold values. In this way, local heat management 830 may dynamically respond to local conditions at database/distributed transaction nodes 810.

For example, local heat management 830 may track computer resource utilization (e.g., processor used, memory used, network and/or other I/O) and/or operation level utilization (e.g., number of queries or other operations performed, buffer cache hit ratio, which indicates how much the buffer cache is used for performing queries, vacuuming (e.g., reflecting oldest transaction identifiers at the table)) and convert the utilization into a number of consumed DCUs. For example, in one embodiment, a DCU=2 GB of memory consumed+0.25 of processor consumed+1 GB of network bandwidth consumed. Note that various other performance metrics, including other resource utilization metrics may be used to determine a DCU. Thus the previous example is not intended to be limiting.

Local heat management 830 may then apply various local scaling rules or policies that indicate different local scaling actions based on local DCU configuration 850, which may include a local DCU maximum value up to which local heat management 830 may scale DCUs. For example, different thresholds may be assessed by local heat management 830 with respect to consumed DCUs corresponding to different actions, such as a rule to scale up DCUs or scale down DCUs. Such rules may increase or decrease an allocated number of DCUs at the node (which may be lower than maximum DCU and not allowed to exceed it). For example, the consumed DCUs is more than 80% of the allocated DCUs for a period of time (e.g., 5 minutes), then the allocated DCUs may be scaled up by some specified number (e.g., 2 DCUs).

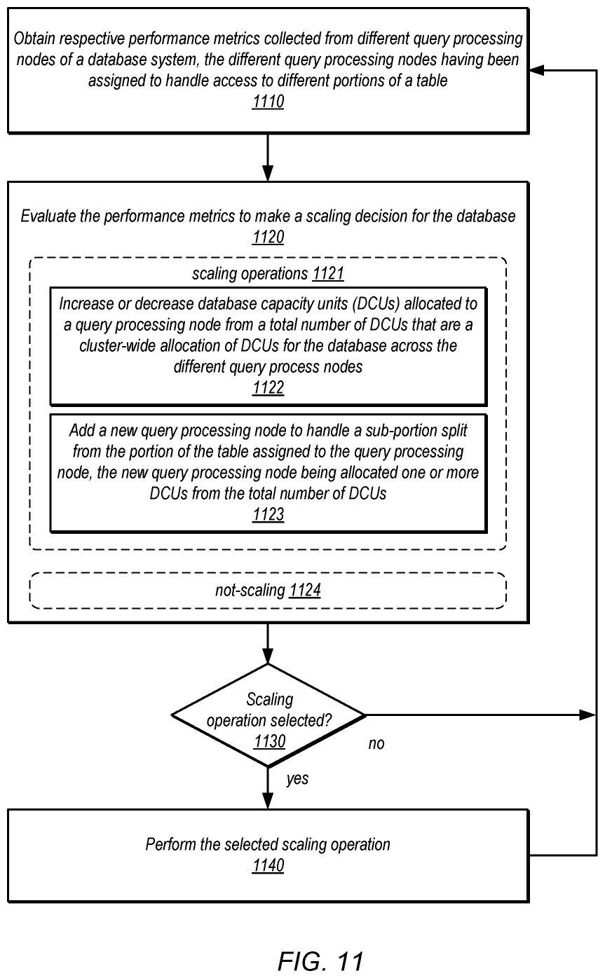

As indicated at 802, various node performance metrics may be determined and provide to heat management 343. In at least some embodiments, cluster-wide heat management 840 may provide node performance metrics 802 as consumed DCUs by the node 810. Like local heat management, heat management 343 may monitor node performance metrics for various scaling events. Scaling events may refer to events that are detected by monitoring or otherwise evaluating performance metrics with respect to different scaling criteria, rules, or policies, which correspond to different scaling decisions, actions or operations. For example, heat management 343 may implement various scaling rules and/or other criteria to detect scaling events and make corresponding scaling decisions with respect to data access/distributed transaction nodes 810 across the entire cluster based on the cluster-wide DCU allocation, as discussed in detail below with regard to FIGS. 11-13. For example, various scaling decisions to modify the local DCU configuration 850 to increase or decrease the local maximum DCU may be made, as indicated at 804 or a decision to add an additional node may be made, using some of the cluster-wide DCU to assign to that additional node.

FIG. 9 is a logical block diagram illustrating scaling DCUs at an individual nodes (data access nodes and distributed transaction nodes of a cluster), according to some embodiments. As discussed in detail below with regard to FIG. 11, in some embodiments, a cluster-wide DCU allocation (e.g., a specified DCU maximum for a database) may be used to make scaling decisions that rebalance DCUs amongst different nodes. For example, heat management 343 may determine to increase local DCU max, as indicated at 904, at data access node 910b. Initially, as depicted at 960a, the cluster-wide DCU allocation may have a reserve pool allocation of DCUs, as indicated at 962. To increase the DCU allocation at node 910, the reserve pool may be used, as depicted at 960b. In order to restore the reserve pool other data access nodes, 910a and 910c, may have their local DCU maxes decreased, as indicated at 902 and 906, in order to restore reserve pool 962, as indicated at cluster-wide DCU allocation 960b. Not all nodes may be affected. In some scenarios (not illustrated), only one of the nodes may have DCUs decreased and another node may remain with the same number of DCUs. Various DCU redistribution options are available to heat management 343 based on the received performance metrics at heat management to make different decisions to add or remove DCUs across the cluster.

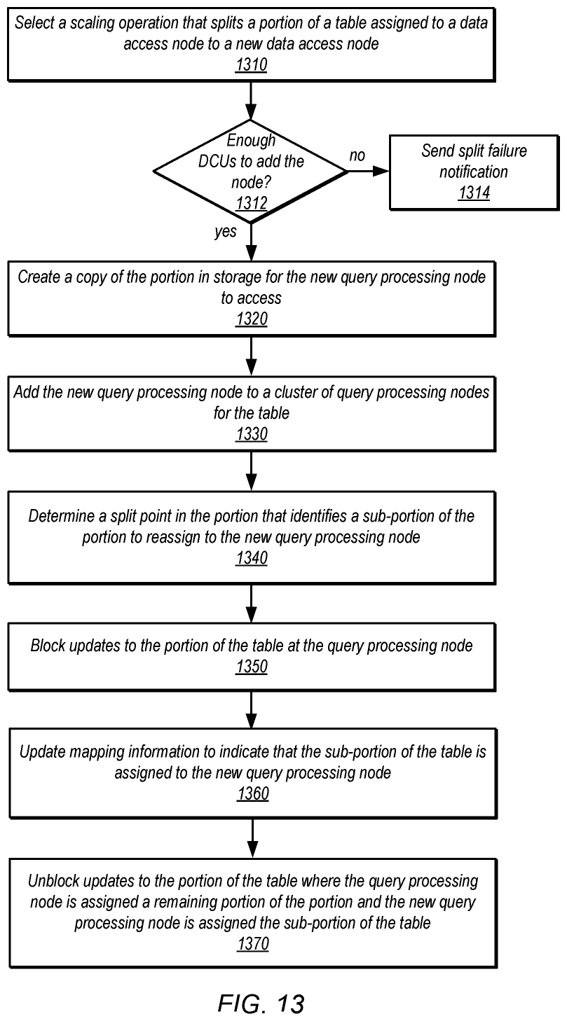

As noted earlier, another option to dissipate heat is to add a node. FIG. 10 is a logical block diagram illustrating splitting a shard at an individual data access node, according to some embodiments. However, as discussed below with regard to FIG. 14, similar techniques can be performed with respect to distributed transaction node. Heat management 343 may select a shard split operation, as indicated at 1022, as discussed below with regard to FIGS. 11 and 13. Heat management 343 may send a request to storage service to create a copy of a shard, as indicated at 1024. Heat management 1026 may then request compute management 342 to provision a new data access node 1026. Then, as indicated at 1028, shard updates may be blocked. Then, as indicated at 1030, an update to metadata 1001 (e.g., a catalog locally stored at various nodes of a cluster or a cluster-wide set of metadata maintained separately) may be made according to a split point that is identified for the source shard. As indicated at 1032, shard updates may then be unblocked, in some embodiments.

The database service and storage service discussed in FIGS. 2 through 10 provide examples of a database system that may implement dynamically scaling a distributed database according to a cluster-wide resource allocation. However, various other types of database systems may make use of dynamically scaling a distributed database according to a cluster-wide resource allocation.

FIG. 11 is a high-level flowchart illustrating various methods and techniques to implement dynamically scaling a distributed database according to a cluster-wide resource allocation, according to some embodiments. Various different systems and devices may implement the various methods and techniques described below, either singly or working together. For example, a database service and storage service as discussed above may implement the various methods. Alternatively, a combination of different systems and devices may implement the various techniques. Therefore, the above examples and or any other systems or devices referenced as performing the illustrated method, are not intended to be limiting as to other different components, modules, systems, or configurations of systems and devices.

As indicated at 1110, respective performance metrics collected from different query processing nodes of a database system, the different query processing nodes having been assigned to handle access to different portions of a table, in some embodiments. For example, these performance metrics may be reported as consumed DCUs by individual query processing nodes (e.g., data access nodes or distributed transaction nodes), in some embodiments. In other embodiments, performance metrics may be reported to in raw form to a control plane component (e.g., heat management 343) and then converted into DCUs.

As indicated at 1120, the performance metrics may be evaluated to make a scaling decision, in some embodiments. Scaling decisions may include selecting between a scaling operation 1121 and not scaling 1124. For example, scaling rules or policies may include a number of different criteria for each decision which may be evaluated in an order. One example may be:
Perform validation checks to see if any in progress work blocks performance of scaling (e.g., another scaling action being performed)
Check for edge case rules to be applied (e.g., special handling for scenarios where database objects, such as tables, are very large)
Evaluate scaling cap rules, which determine whether a node can be scaled up any more
Evaluate scale up rules
Evaluate scale out rules to add a node
Evaluate scale down rules

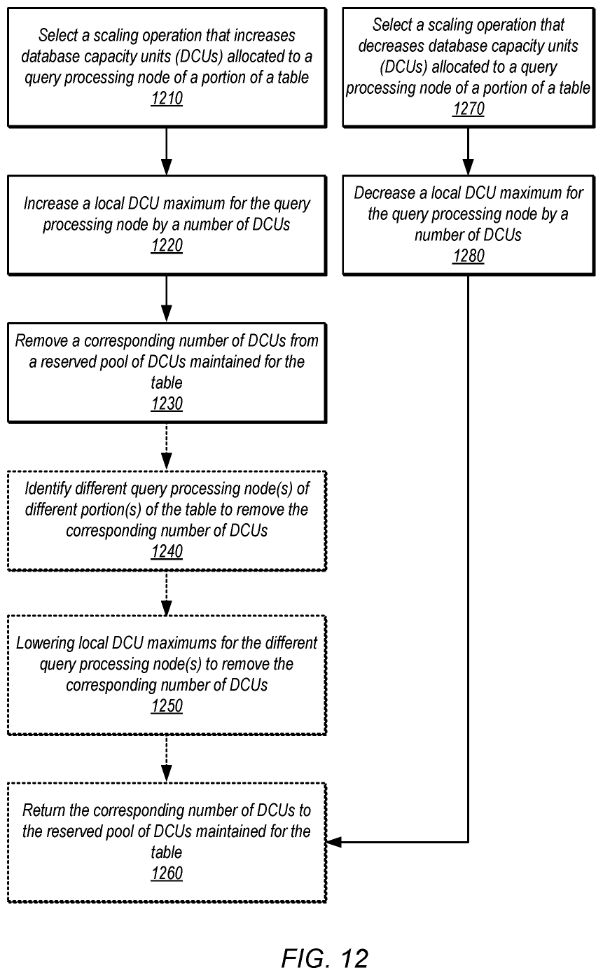

Scaling operations 1121 may include operations such as increasing or decreasing DCUs allocated to a query processing node from a total number of DCUs that are a cluster-wide allocation of DCUs for the table across the different query processing nodes, as indicated at 1122, and discussed in more detail below with regard to FIG. 12. Another scaling operation 1121 may include adding a new query processing node to handle a sub-portion split from the portion of the table assigned to the query processing node, where the new query processing node is allocated one or more DCUs from the total number of DCUs., as indicated at 1123.

Different scaling rules or policies to make individual scaling decisions, as noted above. For example, scaling cap rules (noted above) may determine whether or not an individual node can scale up any more (e.g., no more local max DCU increases can be made because of the capacity limitations of the host systems for the individual node). If a scaling cap rule is satisfied, then a scaling to decision to add a node may be made. Scale up rules may include, for example, determining whether the consumed DCUs of a node, in a last time period (e.g., the last 15 minutes), are greater than or equal to some % (e.g., 80%) of the local max DCU. Another scale up rule may consider an additional metric (e.g., a database load metric, which may reflect use of particular computing resource for another/different period of time, such as CPU utilization for the length of an active session), and compare it to the capacity of that node's computing resource (e.g., is it greater than a number of CPUs available to perform work). Another example scale up rule may be comparing if a percentage of waiting events for processes (e.g., waiting to read from database storage instead of reading data from an in-memory cache) is less than a threshold number. Different criteria may be combined or different metrics combined. For example, an increase in DCUs may also have to be observed in addition to, for example, determining that the database load metric is greater than the resource capacity.

Examples of scaling decisions to add a node (sometimes referred to as “scaling out”) may include determining if the consumed DCUs of a node is a maximum capacity of DCUs for a node (which may be the ultimate limit on DCUs for a node up to which the local max of DCUs may be increased). The number of portions for one or more tables of the database assigned to the node is greater than some number (e.g., >=100,000 portions), then scale out may be performed. Another example may be if after performing a scale up, various load, wait, buffer cache hit ratio or other local performance metrics indicate continued heat on the node. Another example may be to compare the percentage of free-able memory for a past period of time (e.g., last 15 minutes) with respect to a threshold.

Examples of scaling decisions to scale down a node may be if the number of consumed DCUs at a node is less than threshold percentage of is less than 30% of assigned DCUs to that node. The previously described example rules for different scaling decisions are non-limiting. Other thresholds, metrics, or criteria may be considered and applied to making decisions for scaling decisions for a cluster.

The scaling decision may also be not scaling 1124. For example, none of the scaling rules may be satisfied and thus a not scaling decision may be made, which may trigger a wait period of time (e.g., 15 minutes) before reevaluating them. Not scaling 1124 may include or not include a notification or other indicator. For example, a notification may be sent if insufficient DCUs are free to be allocated to perform the scaling operation. Alternatively, not-scaling 1124 may not provoke any notification or indication.

As indicated at 1130, if no scaling operation is performed then the method may return to element 1110, which may wait, for example, a period of time, collect new metrics from the query processing nodes, and re-evaluate, at 1120. If a scaling operation is selected, as indicated by the positive exit from 1130, then selected scaling operation may be performed, as indicated at 1140.

FIG. 12 is a high-level flowchart illustrating various methods and techniques to implement scaling database capacity units (DCUs) at a query processing node of a database system, according to some embodiments. As indicated at 1210, a scaling operation may be selected that increases DCUs allocated to a query processing node of a portion of a table, in some embodiments.

As indicated at 1220, a local DCU maximum for the query processing node by a number of DCUs, in some embodiments. As indicated at 1230, a corresponding number of DCUs may be removed from a reserved pool of DCUs maintained for the table, in some embodiments. As indicated at 1240, different query processing node(s) of different portion(s) of the table may be identified to remove the corresponding number of DCUs, in some embodiments. As indicated at 1250, local DCU maximums for the different query processing node(s) may be lowered to remove the corresponding number of DCUs, in some embodiments. As indicated at 1260, the corresponding number of DCUs may be returned to the reserved pool of DCUs maintained for the table, in some embodiments.

As indicated at 1270, a scaling operation that decreases DCUs allocated to a query processing node of a portion of a table may be selected, in some embodiments. As indicated at 1280, a local DCU maximum for the query processing node may be decreased by a number of DCUs, in some embodiments. As indicated at 1260, the corresponding number of DCUs may be returned to the reserved pool of DCUs maintained for the table, in some embodiments. In some embodiments, DCUs may not be taken from other nodes, therefore elements 1240, 1250, and 1260 are outlined to indicate that in some embodiments they may not be performed (or not performed in some scenarios).

FIG. 13 is a high-level flowchart illustrating various methods and techniques to implement splitting a portion of a table to assign to a new query processing node, according to some embodiments. As indicated at 1310, a scaling operation that splits a portion of a table assigned to a query processing node to a new query processing node, in some embodiments. In some embodiments, an evaluation may be made as to whether enough DCUs in the cluster-wide allocation are available to add the node, as indicated at 1312. If not, then a split failure notification 1314 may be sent, allowing a user to increase specified DCUs for a cluster, if desirable. As indicated at 1320, a copy of the portion may be created in storage for the new query processing node to access, in some embodiments. As indicated at 1330, the new query processing node may be added to a cluster of query processing nodes for the table, in some embodiments. As indicated at 1340, a split point in the portion may be determine that identifies a sub-portion of the portion to reassign to the new query processing node, in some embodiments.

As indicated at 1350, updates to the portion of the table may be blocked at the query processing node, in some embodiments. As indicated at 1360, mapping information may be updated to indicate that the sub-portion of the table is assigned to the new query processing node, in some embodiments. As indicated at 1370, updates to the portion of the table may be unblocked where the query processing node is assigned a remaining portion of the portion and the new query processing node is assigned the sub-portion of the table, in some embodiments.

FIG. 14 is a high-level flowchart illustrating various methods and techniques to implement adding a new distributed transaction node, according to some embodiments. As indicated at 1410, a scaling operation that adds a new distributed transaction node, in some embodiments. For example, the various scale out rules discussed above may be applied to distributed transaction nodes (e.g., an existing distributed transaction node may have reach a DCU cap). In some embodiments, an evaluation may be made as to whether enough DCUs in the cluster-wide allocation are available to add the node, as indicated at 1412. If not, then a split failure notification 1414 may be sent, allowing a user to increase specified DCUs for a cluster, if desirable.

As indicated at 1430, the new distributed transaction node may be added to a network endpoint (e.g., load-balancer, router, or other networking component that directs requests to one of the distributed transaction nodes), in some embodiments. As indicated at 1430, the new distributed transaction node may be included in an update to mapping information to indicate that the new distributed transaction node is available to perform distributed transactions for a database across a cluster, in some embodiments.

The methods described herein may in various embodiments be implemented by any combination of hardware and software. For example, in one embodiment, the methods may be implemented by a computer system (e.g., a computer system as in FIG. 15) that includes one or more processors executing program instructions stored on a computer-readable storage medium coupled to the processors. The program instructions may implement the functionality described herein (e.g., the functionality of various servers and other components that implement the distributed systems described herein). The various methods as illustrated in the figures and described herein represent example embodiments of methods. The order of any method may be changed, and various elements may be added, reordered, combined, omitted, modified, etc.

FIG. 15 is a block diagram illustrating an example computer system that may implement the various techniques of commit time logging for time-based multi-version concurrency control discussed above with regard to FIGS. 1-11, according to various embodiments described herein. For example, computer system 3000 may implement a data processing node, distributed transaction node, and/or a storage node of a separate storage system that stores database tables and associated metadata on behalf of clients of the database tier, in various embodiments. Computer system 3000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of computing device.

Computer system 3000 includes one or more processors 3010 (any of which may include multiple cores, which may be single or multi-threaded) coupled to a system memory 3020 via an input/output (I/O) interface 3030. Computer system 3000 further includes a network interface 3040 coupled to I/O interface 3030. In various embodiments, computer system 3000 may be a uniprocessor system including one processor 3010, or a multiprocessor system including several processors 3010 (e.g., two, four, eight, or another suitable number). Processors 3010 may be any suitable processors capable of executing instructions. For example, in various embodiments, processors 3010 may be general-purpose or embedded processors implementing any of a variety of instruction set architectures (ISAs), such as the x86, PowerPC, SPARC, or MIPS ISAs, or any other suitable ISA. In multiprocessor systems, each of processors 3010 may commonly, but not necessarily, implement the same ISA. The computer system 3000 also includes one or more network communication devices (e.g., network interface 3040) for communicating with other systems and/or components over a communications network (e.g. Internet, LAN, etc.). For example, a client application executing on system 3000 may use network interface 3040 to communicate with a server application executing on a single server or on a cluster of servers that implement one or more of the components of the database systems described herein. In another example, an instance of a server application executing on computer system 3000 may use network interface 3040 to communicate with other instances of the server application (or another server application) that may be implemented on other computer systems (e.g., computer systems 3090).

In the illustrated embodiment, computer system 3000 also includes one or more persistent storage devices 3060 and/or one or more I/O devices 3080. In various embodiments, persistent storage devices 3060 may correspond to disk drives, tape drives, solid state memory, other mass storage devices, or any other persistent storage device. Computer system 3000 (or a distributed application or operating system operating thereon) may store instructions and/or data in persistent storage devices 3060, as desired, and may retrieve the stored instruction and/or data as needed. For example, in some embodiments, computer system 3000 may host a storage system server node, and persistent storage 3060 may include the SSDs attached to that server node.

Computer system 3000 includes one or more system memories 3020 that may store instructions and data accessible by processor(s) 3010. In various embodiments, system memories 3020 may be implemented using any suitable memory technology, (e.g., one or more of cache, static random access memory (SRAM), DRAM, RDRAM, EDO RAM, DDR 10 RAM, synchronous dynamic RAM (SDRAM), Rambus RAM, EEPROM, non-volatile/Flash-type memory, or any other type of memory). System memory 3020 may contain program instructions 3025 that are executable by processor(s) 3010 to implement the methods and techniques described herein (e.g., various features of fine-grained virtualization resource provisioning for in-place database scaling). In various embodiments, program instructions 3025 may be encoded in native binary, any interpreted language such as Java™ byte-code, or in any other language such as C/C++, Java™, etc., or in any combination thereof. In some embodiments, program instructions 3025 may implement multiple separate clients, server nodes, and/or other components.

In some embodiments, program instructions 3025 may include instructions executable to implement an operating system (not shown), which may be any of various operating systems, such as UNIX, LINUX, Solaris™, MacOS™, Windows™, etc. Any or all of program instructions 3025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 3000 via I/O interface 3030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 3000 as system memory 3020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 3040.

In some embodiments, system memory 3020 may include data store 3045, which may be configured as described herein. For example, the information described herein as being stored by the database tier (e.g., on a primary node), such as a transaction log, an undo log, cached page data, or other information used in performing the functions of the database tiers described herein may be stored in data store 3045 or in another portion of system memory 3020 on one or more nodes, in persistent storage 3060, and/or on one or more remote storage devices 3070, at different times and in various embodiments. Along those lines, the information described herein as being stored by a read replica, such as various data records stored in a cache of the read replica, in-memory data structures, manifest data structures, and/or other information used in performing the functions of the read-only nodes described herein may be stored in data store 3045 or in another portion of system memory 3020 on one or more nodes, in persistent storage 3060, and/or on one or more remote storage devices 3070, at different times and in various embodiments. Similarly, the information described herein as being stored by the storage tier (e.g., redo log records, data pages, data records, and/or other information used in performing the functions of the distributed storage systems described herein) may be stored in data store 3045 or in another portion of system memory 3020 on one or more nodes, in persistent storage 3060, and/or on one or more remote storage devices 3070, at different times and in various embodiments. In general, system memory 3020 (e.g., data store 3045 within system memory 3020), persistent storage 3060, and/or remote storage 3070 may store data blocks, replicas of data blocks, metadata associated with data blocks and/or their state, database configuration information, and/or any other information usable in implementing the methods and techniques described herein.

In one embodiment. I/O interface 3030 may coordinate I/O traffic between processor 3010, system memory 3020 and any peripheral devices in the system, including through network interface 3040 or other peripheral interfaces. In some embodiments, I/O interface 3030 may perform any necessary protocol, timing or other data transformations to convert data signals from one component (e.g., system memory 3020) into a format suitable for use by another component (e.g., processor 3010). In some embodiments, I/O interface 3030 may include support for devices attached through various types of peripheral buses, such as a variant of the Peripheral Component Interconnect (PCI) bus standard or the Universal Serial Bus (USB) standard, for example. In some embodiments, the function of I/O interface 3030 may be split into two or more separate components, such as a north bridge and a south bridge, for example. Also, in some embodiments, some or all of the functionality of I/O interface 3030, such as an interface to system memory 3020, may be incorporated directly into processor 3010.

Network interface 3040 may allow data to be exchanged between computer system 3000 and other devices attached to a network, such as other computer systems 3090 (which may implement one or more storage system server nodes, query processing nodes, such as data access nodes and distributed query processing nodes of a cluster, and/or clients of the database systems described herein), for example. In addition, network interface 3040 may allow communication between computer system 3000 and various I/O devices 3050 and/or remote storage 3070. Input/output devices 3050 may, in some embodiments, include one or more display terminals, keyboards, keypads, touchpads, scanning devices, voice or optical recognition devices, or any other devices suitable for entering or retrieving data by one or more computer systems 3000. Multiple input/output devices 3050 may be present in computer system 3000 or may be distributed on various nodes of a distributed system that includes computer system 3000. In some embodiments, similar input/output devices may be separate from computer system 3000 and may interact with one or more nodes of a distributed system that includes computer system 3000 through a wired or wireless connection, such as over network interface 3040. Network interface 3040 may commonly support one or more wireless networking protocols (e.g., Wi-Fi/IEEE 802.11, or another wireless networking standard). However, in various embodiments, network interface 3040 may support communication via any suitable wired or wireless general data networks, such as other types of Ethernet networks, for example. Additionally, network interface 3040 may support communication via telecommunications/telephony networks such as analog voice networks or digital fiber communications networks, via storage area networks such as Fibre Channel SANs, or via any other suitable type of network and/or protocol. In various embodiments, computer system 3000 may include more, fewer, or different components than those illustrated in FIG. 15 (e.g., displays, video cards, audio cards, peripheral devices, other network interfaces such as an ATM interface, an Ethernet interface, a Frame Relay interface, etc.)

It is noted that any of the distributed system embodiments described herein, or any of their components, may be implemented as one or more network-based services. For example, a read-write node and/or read-only nodes within the database tier of a database system may present database services and/or other types of data storage services that employ the distributed storage systems described herein to clients as network-based services. In some embodiments, a network-based service may be implemented by a software and/or hardware system designed to support interoperable machine-to-machine interaction over a network. A web service may have an interface described in a machine-processable format, such as the Web Services Description Language (WSDL). Other systems may interact with the network-based service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed is:

1. A system, comprising:
at least one processor; and
a memory, storing program instructions that when executed by the at least one processor, cause the at least one processor to implement a database system, configured to:
monitor performance metrics collected from a cluster of different query processing nodes of the database system assigned to handle access to different shards of a system-managed table for a scaling event;
responsive to detecting the scaling event:
determine a scaling decision for a query processing node of the different query processing nodes based, at least in part, on an evaluation of the respective performance metrics, wherein the scaling decision selects one of a plurality scaling operations, wherein the plurality of scaling operations comprise:
increasing or decreasing database capacity units (DCUs) allocated to the query processing node from a total number of DCUs that are a cluster-wide allocation of DCUs for the table across the different query process nodes; and
adding a new query processing node to handle a sub-portion split from the shard of the table assigned to the query processing node, wherein the new query processing node is allocated one or more DCUs from the total number of DCUs; and
perform the scaling operation selected by the database system with respect to the query processing node.

2. The system of claim 1, wherein increasing the DCUs allocated to the query processing node comprises:
increasing a local DCU maximum at the query processing node by a number of DCUs;
removing a corresponding number of DCUs from a reserve pool of DCUs in the cluster-wide allocation of DCUs;
identifying one or more other query processing nodes of the plurality of query processing nodes to remove the corresponding number of DCUs;
lowering respective local DCU maximums at the identified other query processing nodes to remove the corresponding number of DCUs; and
returning the corresponding number of DCUs to the reserved pool of DCUs.

3. The system of claim 1, wherein adding the new query processing node to handle the sub-portion split from the shard of the table assigned to the query processing node comprises:
creating a copy of the shard for the new query processing node to access;
adding the new query processing node to a cluster of query processing nodes comprising the plurality of query processing nodes;
determining a split point in the shard that identifies the sub-portion of the shard to reassign to the new query processing node;
blocking updates to the shard at the query processing node;
updating mapping information to indicate that the sub-portion of the shard is assigned to the new query processing node; and
unblocking the updates to the shard, wherein the query processing node is assigned a remaining portion of the shard and the new query processing node is assigned the sub-portion.

4. The system of claim 1, wherein the database system is a relational database service implemented as part of a provider network and wherein the system-managed table is created in response to a request received at the database service to create the system-managed table.

5. A method, comprising:
evaluating, by a database system, respective performance metrics collected from a cluster of different query processing nodes of the database system assigned to handle access to different portions of a table, wherein the evaluating determines a scaling decision for a query processing node of the different query processing nodes, wherein the scaling decision selects one of a plurality scaling operations, wherein the plurality of scaling operations comprise:
increasing or decreasing database capacity units (DCUs) allocated to the query processing node from a total number of DCUs that are a cluster-wide allocation of DCUs for the table across the different query processing nodes; and
adding a new query processing node to handle a sub-portion split from the portion of the table assigned to the query processing node, wherein the new query processing node is allocated one or more DCUs from the total number of DCUs; and
performing, by the database system, the scaling operation selected by the database system with respect to the query processing node.

6. The method of claim 5, wherein increasing the DCUs allocated to the query processing node comprises:
increasing a local DCU maximum at the query processing node by a number of DCUs;
removing a corresponding number of DCUs from a reserve pool of DCUs in the cluster-wide allocation of DCUs;
identifying one or more other query processing nodes of the plurality of query processing nodes to remove the corresponding number of DCUs;
lowering respective local DCU maximums at the identified other query processing nodes to remove the corresponding number of DCUs; and
returning the corresponding number of DCUs to the reserved pool of DCUs.

7. The method of claim 5, wherein decreasing the DCUs allocated to the query processing node comprises:
decreasing a local DCU maximum at the query processing node by a number of DCUs; and
adding a corresponding number of DCUs to a reserve pool of DCUs in the cluster-wide allocation of DCUs.

8. The method of claim 5, wherein adding the new query processing node to handle the sub-portion split from the portion of the table assigned to the query processing node comprises:
creating a copy of the portion for the new query processing node to access;
adding the new query processing node to a cluster of query processing nodes comprising the plurality of query processing nodes;
determining a split point in the portion that identifies the sub-portion of the portion to reassign to the new query processing node;
blocking updates to the portion at the query processing node;
updating mapping information to indicate that the sub-portion of the portion is assigned to the new query processing node; and
unblocking the updates to the portion, wherein the query processing node is assigned a remaining portion of the portion and the new query processing node is assigned the sub-portion.

9. The method of claim 5, wherein the total number of DCUs is specified in a request received at the database system.

10. The method of claim 5, wherein the total number of DCUs is increased from a prior total number according to a request to increase DCUs received at the database system.

11. The method of claim 5, further comprising:
receiving, at the database system, a request to perform a split operation for the table; and
responsive to the request, adding the new query processing node to handle the sub-portion split from the portion of the table assigned to the query processing node, wherein the new query processing node is allocated one or more DCUs from the total number of DCUs.

12. The method of claim 5, further comprising:
evaluating, by the database system, further respective performance metrics collected from the plurality of different query processing nodes of the database system, wherein the evaluating determines a further scaling decision selecting a further scaling operation for a different query processing node of the different query processing nodes; and
determining that a minimum number of DCUs from the total number of DCUs are not available to perform the further scaling operation.

13. The method of claim 5, wherein the plurality of query processing nodes comprise at least one distributed transaction node and at least one data access node and wherein the query processing node is the at least distributed transaction node.

14. One or more non-transitory, computer-readable storage media, storing program instructions that when executed on or across one or more computing devices cause the one or more computing devices to implement:
obtaining performance metrics collected from a cluster of different query processing nodes of a database system assigned to handle access to different portions of a table;
determining a scaling decision for a query processing node of the different query processing nodes based, at least in part, on an evaluation of the respective performance metrics, wherein the scaling decision selects one of a plurality scaling operations, wherein the plurality of scaling operations comprise:
increasing or decreasing database capacity units (DCUs) allocated to the query processing node from a total number of DCUs that are a cluster-wide allocation of DCUs for the table across the different query process nodes; and
adding a new query processing node to handle a sub-portion split from the portion of the table assigned to the query processing node, wherein the new query processing node is allocated one or more DCUs from the total number of DCUs; and
causing performance of the scaling operation selected by the database system with respect to the query processing node.

15. The one or more non-transitory, computer-readable storage media of claim 14, wherein increasing the database capacity units (DCUs) allocated to the query processing node comprises:
increasing a local DCU maximum at the query processing node by a number of DCUs; and
removing a corresponding number of DCUs from a reserve pool of DCUs in the cluster-wide allocation of DCUs.

16. The one or more non-transitory, computer-readable storage media of claim 14, wherein decreasing the database capacity units (DCUs) allocated to the query processing node comprises:
decreasing a local DCU maximum at the query processing node by a number of DCUs; and
adding a corresponding number of DCUs to a reserve pool of DCUs in the cluster-wide allocation of DCUs.

17. The one or more non-transitory, computer-readable storage media of claim 14, wherein adding the new query processing node to handle the sub-portion split from the portion of the table assigned to the query processing node comprises:
creating a copy of the portion for the new query processing node to access;
adding the new query processing node to a cluster of query processing nodes comprising the plurality of query processing nodes;
determining a split point in the portion that identifies the sub-portion of the portion to reassign to the new query processing node;
blocking updates to the portion at the query processing node;
updating mapping information to indicate that the sub-portion of the portion is assigned to the new query processing node; and
unblocking the updates to the portion, wherein the query processing node is assigned a remaining portion of the portion and the new query processing node is assigned the sub-portion.

18. The one or more non-transitory, computer-readable storage media of claim 14, wherein the total number of DCUs is specified in a request received at the database system.

19. The one or more non-transitory, computer-readable storage media of claim 14, wherein an initial distribution of at least some of the total number of DCUs is made across the plurality of query processing nodes responsive to creating the table as a system-managed table or responsive to a request enabling the table to be a system-managed table.

20. The one or more non-transitory, computer-readable storage media of claim 14, wherein the database system is a database service implemented as part of a provider network and wherein the table is created as a system managed table in response to a request received at the database service.
